(19) United States
(12) Patent Application Publication
(10) Pub. No.: US 2006/0047829 A1
(43) Pub. Date: Mar. 2, 2006

(54) Differentiated connectivity in a pay-per-use public data access system

(76) Inventors: Arup Acharya, Nanuet, NY (US); Chatschik Bisdikian, Chappaqua, NY (US); Young-Bae Ko, Gunpo City (KR); Archan Misra, Irvington, NY (US); Marcel C. Rosu, Ossining, NY (US); Javier Gomez-Castellanos, Tlalpan (MX)

Correspondence Address: THE LAW OFFICE OF IDO TUCHMAN, 69-60 108ST., SUITE 503, FOREST HILLS, NY, 11375, US

(21) Appl. No.: 10/932,289

(22) Filed: Sep. 2, 2004

(51) Int. Cl. G06F 15/16

(52) U.S. Cl. 709/229

(57) ABSTRACT

Provides methods and apparatus for offering tiered application services for access to network services on a pay-per-use basis in public access networks. Using personal devices, the user can access different tiers of application services on demand, without the need of any preexisting association, e.g., subscription, with the service provider of the wireless access system. Such on-demand access is obtained by providing a variety of personal identifiers, such as a credit card number or frequent flier identification. Moreover, the service offering allows a user through a personal device to modify, enhance or degrade the currently established tier of application services during the lifetime of the user's association with the access network. A network-level enforcement mechanism at access points within the access network ensures user access only to application services within the application service tier that they have paid for, and deny service accesses not within that tier.

### FIELD OF THE INVENTION

This invention is directed to the field of computer networks. It is more particularly directed to Internet access via a publicly accessible networking infrastructure.

### BACKGROUND

This invention is concerned with mechanisms by which users, using their own personal devices such as notebook computers and personal digital assistants (PDAs), access packet-based networking services, which are offered by service providers at public locations such as airports, malls, hotels, etc. Such public-access service providers may offer a variety of wireline or wireless technologies by which people connect their personal devices to the network and its associated services.

With the advent of new wireless technology standards for local and personal area networks (wireless LANs and wireless PANs, respectively), we are witnessing a rapid increase in the number of offerings of public services, especially of the type considered in this invention. For example, public wireless access may be provided through wireless LAN technologies, such as the ones based on the IEEE 802.11 family of standards, or wireless PAN technologies, such as the Bluetooth wireless technology.

Typically, packet-based, data service offerings require users to first pre-register (e.g., subscribe) to a data service provider, like an Internet Service Provider (ISP), thereby establishing a long “paying” relation with the provider. Such a process is usually accomplished in an off-line manner, with the provider-subscriber relationship established and activated before the user can gain access to such public services. Such a subscriber relationship often includes the definition of a user profile, which specifies the range of services that the individual user is authorized to access. An ISP typically provides a local or even toll-free telephone number that permits access to the same ISP at an additional incremental cost (in addition to the subscription fee) from many geographically remote locations. However, for access to data services via a wireless public offering, this mechanism has a serious shortcoming: if users approach a public access infrastructure which is operated by a provider different from the ones with which they have already established subscriptions, they will be denied access unless they subscribe with this new provider as well. Such a restriction defeats the premise of a public access infrastructure, which would ideally like to serve (and make money from) as many users as possible at all times.

Furthermore, the current schemes for public access to network services, which typically employ wireless technologies, usually define a single tier of service. For example, a typical service is simply access to the World-Wide-Web (or “the Web”). Such a definition of services does not consider scenarios where users can access certain premium services on demand through their own devices. There generally exist no mechanisms that allow users to choose one or more such premium services on-the-fly at any time, without requiring a pre-established relation to such services. Even if the service offering did have multiple tiers (or groups of services), users would have to select their desired tier of service ahead of time. The selected service tier remains unchanged for the duration that a user accesses services provided by the service provider. In other words, current service offerings via public access infrastructures are generally not capable of providing standard device users different and dynamically adjustable tiers of service. Such service offerings would also need mechanisms to dynamically adjust the payment policies for users based on their selected set of services.

One possible solution is to use tiered services by installing a special code in client devices. This special code would affect the communications protocol stack, and necessitates the use of a new specific protocol. Every packet generated by these client devices needs to be modified using this extra and special code. Of course, the network elements inside these networks must run a complementary part of the new specific protocol in order to be able to read these modified packets. It would be advantageous to have methods in which this change in the protocol stack is not required. The methods should be able to use existing (TCP/IP) standards so as not to require a new protocol to be implemented by client devices, not to require that a client device needs to modify each and every transmission it makes, and not to require that the devices in the network need to modify their communication protocols stacks to understand a newly designed protocol.

### SUMMARY OF THE INVENTION

It is thus an aspect of this invention to allow providers of public network services to offer different tiers of application service to users of those application services. The users employ their own personal devices, to which no special modifications have been made to accommodate the teachings of this invention, to negotiate and dynamically adjust their desired tier of application service on a per-use basis, as well as during an ongoing use.

Another aspect of the invention is an enforcement mechanism that is applicable in the communications infrastructure supporting such public service offerings. The enforcement mechanism is applicable to elements internal to the infrastructure, such as a router device, or at its edge, such as a wireless access point. The enforcement mechanism ensures that individual users are able to access only those application services that are within the application service tier that they have selected and denies access to all application services that do not fall within that tier. The enforcement mechanism may further be supplemented by means to alert users when they attempt to access a particular application service that does not fall within their current selected tier, and means by which users, again using their own devices, may renegotiate new desired application service tiers on-the-fly so that they can access new application services if desired.

Yet another aspect of this invention is an enforcement mechanism, with the same objectives as aforementioned, which is applicable beyond the communications elements of the infrastructure (e.g., the routers and the wireless access points), such as the devices and software that operate at protocol layers higher than those used in the communications infrastructure. With such an enforcement mechanism, filter servers can be used over the communication infrastructure to restrict, say, Web traffic from users to reach only Web services belonging to the tier of application service they have selected.

A further aspect of the present invention is to enable users to access dynamically selectable tiered application services offered at public places using their own devices on a “pay-per-use” basis, using various means of “on-the-spot” payment, such as credit card information, frequent flier information, a temporary identification information such as a hotel room number, and so on, without requiring a preexisting subscription with the service provider of the data offering. It is an additional aspect of this invention to utilize payment policies that charge users relative to the service they have selected and accessed using their own devices. These payment policies can be based on various criteria including the degree of user activity in terms of the amount of traffic transferred to and/or from the user, or the duration for which a selected tier of application service is provided (the session time).

The foregoing and other features, utilities and advantages of the invention will be apparent from the following more particular description of various embodiments of the invention as illustrated in the accompanying drawings.

### BRIEF DESCRIPTION OF THE DRAWINGS

FIG. 1 shows an example architecture of a system for providing wireless network access, along with the actions executed by a user and the system for providing a desired tier of application service.

FIG. 2 shows an example of three major functional steps used in accordance with this invention to allow individual users to specify and obtain access to authorized application services. The three steps are:

a) registration, which lets users specify their choice among the available application services,

b) control notification, which lets the specific enforcement devices know the appropriate access profile for a specific user and

c) enforcement, which allows the appropriate network devices to police individual packets, connections or sessions related to a specific user's device to ensure that they always correspond to authorized application services.

FIG. 3 shows steps taken by registration-related entities (especially the user device and the registration server) during a user's registration process, and includes mechanisms on the network side to verify a user's credentials, and to accept the user's choice among the available tiers of application service.

FIG. 4 shows an example of steps included in an actual enforcement process. This enforcement mechanism includes an inspection of the specific packet to verify that it conforms to the application services currently authorized for the specific user, as well as any necessary updates for accounting purposes.

FIG. 5 shows steps included in a process by which individual users can dynamically alter their chosen tier of application service.

FIG. 6 shows a process by which users terminate (de-register) their current sessions. Such de-registration is useful to ensure that the network frees up any resources that have been reserved for a specific user, and also to ensure that users are charged accurately for their own activity (especially when the users are charged on the basis of the duration of their sessions).

FIG. 7 shows an exemplary embodiment for managing and terminating a session without the user having to explicitly act for the termination.

FIG. 8 shows an embodiment for the steps followed by the registration server to decide how to proceed if it receives a cookie.

FIG. 9 shows an example of a precise mechanism of access control (i.e., enforcement). It describes an example implementation of such an enforcement mechanism via the use of tables in a router that list specific destinations, protocols or combination thereof, that an individual user can or cannot access. The access control framework of FIG. 9 can also be applied to enforcement mechanisms that occur at different layers, and possibly at service-level entities.

FIG. 10 shows an analogue of FIG. 9, for a case when access control is performed via a wireless access point or a Web proxy.

### DETAILED DESCRIPTION OF THE INVENTION

The present invention provides methods, apparatus and systems for a user to choose between multiple tiers of application services that are made available over a public network access infrastructure. One novel aspect of this invention is that it allows users employing standard and/or nonstandard device protocols to obtain access to such differentiated tiers of application services even though they have no previously provisioned subscriber relationship with the corresponding service provider. Moreover, another unique feature of this invention is that it allows users to dynamically add to and/or delete from their current list of authorized application services. Such changes also result in appropriate and/or corresponding changes to the charging (or billing) mechanism.

A service is defined herein as a destination end-point (such as a company's Web page), a corporate server application (such as a corporate Lotus Notes mail server), and so on. This application level definition of a service is in contrast to network level services, such as the communications bandwidth allowed for communicating over the Internet, say 56 or 128 Kbps, independently of what the destination is of communications is. An example of grouping services in tiers according to this network bandwidth level definition of a service is the Building Broadband Service Manager (BBSM) system from Cisco (the product description can be found at http://www.cisco.com/warp/public/cc/pd/nemnsw/bbsm/prodlit/blbsm_wp.pdf ). With BBSM, the network bandwidth is regulated from the BBSM “box” and to the Internet. The bandwidth constraint does not extend all the way to the user personal devices.

Users may use their own personal data devices, such as notebook computers or personal digital assistants (PDAs). Users may temporary use other computing devices as well, like a kiosk, and this invention does not exclude such a possibility. However, for the purpose of this invention such other devices are assumed to behave exactly as if they were the users' own “everyday” computing devices, without the requirement of incorporating in these devices any specific set of software or hardware components that would uniquely and exclusively empower these devices to operate according to. In this way users harvest the benefits of the teachings of this invention.

It should be noted that there are alternative approaches for deploying public wireless services. For example the CHOICE network (Microsoft technical report: MSR-TR-2000-21, February 2000) proposes the use of specialized software to be embedded on personal devices to facilitate accessing the public services by modifying each and every data packet transmitted by these devices. The CHOICE network, like the BBSM solution from Cisco mentioned earlier, depends on specific features of the Windows operating platforms (either the server or the client versions of it). This creates an operational assumption of a communications and computing homogeneity for the devices engaged in supporting the network. Such a configuration can reduce or eliminate the vast majority of existing or developing devices that generally employ standard protocols.

In contrast, the present invention does not mandate making any changes on a personal device for accessing the wireless network, and does not require any modification on the data packets transmitted by these devices to achieve its various. The teachings of this invention are applicable on unmodified devices and communication protocols, and it can be applied in a non-homogeneous computing and communications environment by devices that use established, open communications standards, like the TCP/IP suite of Internet protocols, that are already supported by the overwhelming majority of personal (IP capable) devices running on different types of operating systems. In other words, for this invention, the personal devices can be built on a software and hardware platform that is independent of the software and hardware platform that the network support devices with which the personal device interacts for its configuration.

The service offerings considered for an embodiment of this invention are generally based on ubiquitous, IP-based Internet technologies; an access technology is based on a wireless local communications technology that operates in an unlicensed radio frequency band, such as IEEE 802.11b wireless LAN or Bluetooth wireless PAN. Clearly, those skilled in the art could build additional embodiments of this invention without departing from the spirit of this invention. For example, skilled artisans could use alternative access technologies such as infrared or Ethernet, or could use the dynamic pay-per-use arrangement as a way for subscription-based customers to occasionally access a tier of premium application services that does not fall within their default subscription profile.

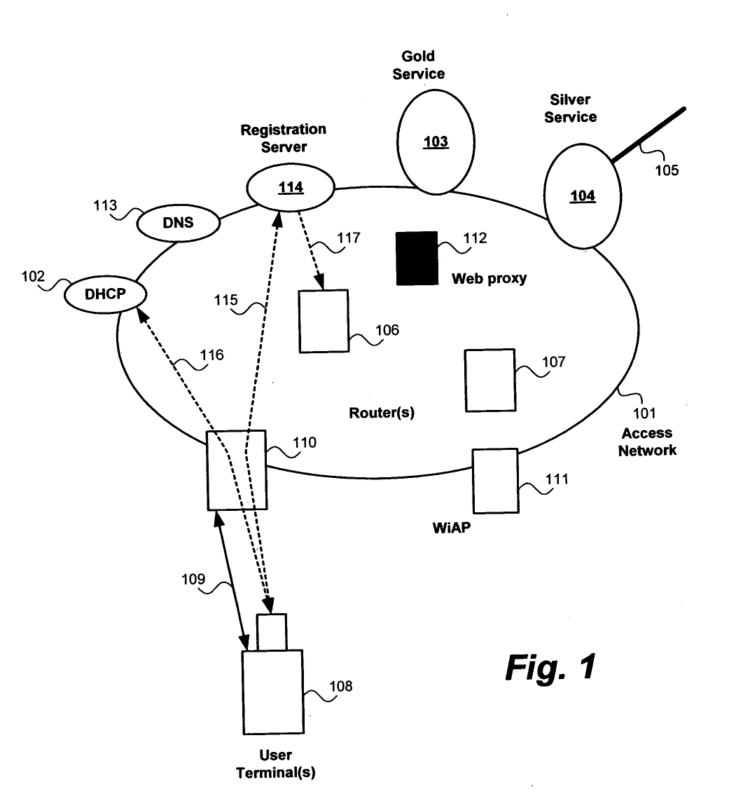

FIG. 1 describes the architecture of a system for providing wireless network access to mobile users and their devices at wireless hot-spots in public areas such as airports according to one embodiment of the present invention. The figure also highlights the steps executed by a user to obtain a desired tier of application service. The access network 101 consists of routers (e.g., 106, 107) and wireless access points (WiAPs) (e.g., 110, 111). User devices or user terminals 108 connect to this access network through a wireless connection 109 to an access point (110 in FIG. 1). In addition to network-layer entities, such as access points and routers, the access network may also consist of network support services such as a DHCP (Dynamic Host Configuration Protocol) server 102, a DNS (Domain Name Service) server 113, and Web proxies (e.g., 112, 117). The DHCP and DNS entities are commonplace elements in most IP-based networks and provide various pieces of configuration information and query-resolution support to IP-based user terminals. The Web proxies are used to manage access to Web servers from user terminals. Specific to the present invention, the access network includes a registration server 114, which is used to interactively establish the tier of application service desired by an individual user.

As an example of the possible tiers of differentiating between tiers of application services, FIG. 1 shows two application service tiers, Gold 103 and Silver 105. Each tier of application services is defined by a collection (or group) of one or more services. For example, the Silver service tier 104 includes access to the general Internet 105 in FIG. 1. The Gold service tier could include a service for providing video clips to the user terminal, in addition to all services included in the Silver service tier. These tiers of application services can exist statically, i.e., the Silver, say, application service tier may always include the same set of application services in it (or at least be updated infrequently). On the other hand, the assignment of application services in tiers can be dynamic, where the application services “assigned” into a tier may change based on various criteria. In some embodiments, services are added or subtracted based on a combination of criteria such as being based on: quality of application service considerations; on enforcing admission control; on the time of the day; applying different charging models to application services at different times, and so on.

After a user terminal 108 enters such a system and establishes a wireless link with an access point, it executes the DHCP protocol to obtain an IP address for the user terminal. This step is shown as item 116 in FIG. 1. Following this step, the user terminal contacts the registration server 114 via a standard Web browser, using the standard HTTP protocol. The registration server provides, among other things, a Web-based listing on the user terminal of the various tiers of application services that are available, and their associated charges. The assignment of services into tiers may be static or dynamic based on the current availability of a service, promotional or other considerations, and so on. At this point, the user enters an identifier, e.g., a credit card number or a frequent flier number, and the desired tier of application service into the browser and sends this information to the registration server. These steps are collectively shown as item 115 in FIG. 1.

Upon a proper validation, the identifier supplied by the user is also used to charge eventually the user for the desired application service tier. Upon acceptance and validation of the identifier, the registration server issues a control notification to the appropriate enforcement device, informing it that the corresponding user is able to access those application services that fall within his/her selected service tier. The enforcement device reacts to this information by placing a set of controls to regulate the user's traffic within the access network. This step is shown as item 117 in FIG. 1. In alternate implementations, the enforcement device could be either a router (106), an access point (110) or a Web proxy (117). The control mechanism would then include the placement of traffic filters at the appropriate enforcement device. Different example embodiments of this control and enforcement mechanism are described later.

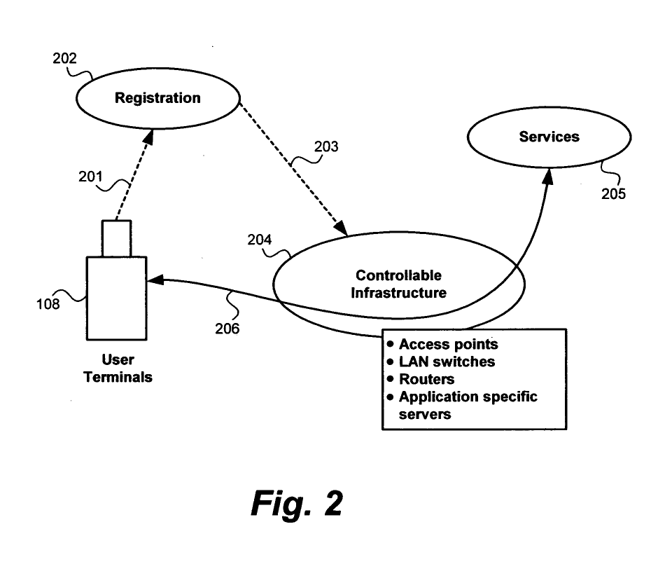

FIG. 2 shows three functional steps used for this invention to allow individual users to specify and obtain access to authorized application services. The three steps are:

a) registration, which lets users specify their choice among the available application services,

b) control notification, which lets the specific enforcement devices know the appropriate access profile for a specific user and

c) enforcement, which allows the appropriate network devices to police individual packets, connections or sessions related to a specific user's device to ensure that they always correspond to authorized application services.

Thus, FIG. 2 highlights steps of this invention for providing user terminals access to various tiers of application services. In particular, a user terminal 108 first goes through registration 201 with a registration authority 202. During registration, among other things, the user terminal is identified by a unique identifier. This identifier should be unique for the duration of the associated sessions, i.e., until the time that the user terminal finishes its association with the access network 101 and the application services available through it. Because the access network can be controlled, configured and/or reconfigured on-the-fly based on application service tier selections by its users, the access network 101 in FIG. 1 is also identified as a controllable infrastructure in FIG. 2. This identifier may be a fixed one, like the medium access (MAC) address of the communication hardware subsystem that the user terminal uses, or a temporary one as are IP addresses assigned by a DHCP server to a user terminal, or a Web cookie provided to a Web browser application running on the user terminal.

By using an identifier that is not directly based on either a network interface (e.g., the MAC address), or on the specific configuration parameters provided by the access network infrastructure (e.g., the IP address), the registration mechanism allows a user terminal to maintain its association with the registration server even if its network connectivity changes (e.g., a new network interface is plugged in, or DHCP configures a new IP address). In these cases, the user terminal may share part of the responsibility for informing the registration server of any changes in its device or network specific configuration parameters.

The registration authority 202 will record the identifier, as well as the tier of application service that the user of the terminal has requested. With this knowledge, the registration authority will then condition the communication network to accommodate the new user and his/her selected tier of application service. The conditioning action includes principally of passing on this binding information between the device's identifier and the tier of application service, information via control signaling 203 to some or all of the nodes of the controllable access infrastructure.

As an example, the registration authority (also called the registration server) may:

a) pass the MAC address of the user terminal, along with the tier of application service, to access points and LAN switches, or

b) pass the IP address of the user terminal, along with the tier of application service, to the network routers, or

c) pass the Web cookie/IP address, along with the tier of application service, to a Web proxy located in the network, or d) inform an application specific server to accept or reject traffic from a specific user terminal. Using this information, the appropriate network node will block, or let pass, traffic 206 from/to the user terminal to/from those services 205.

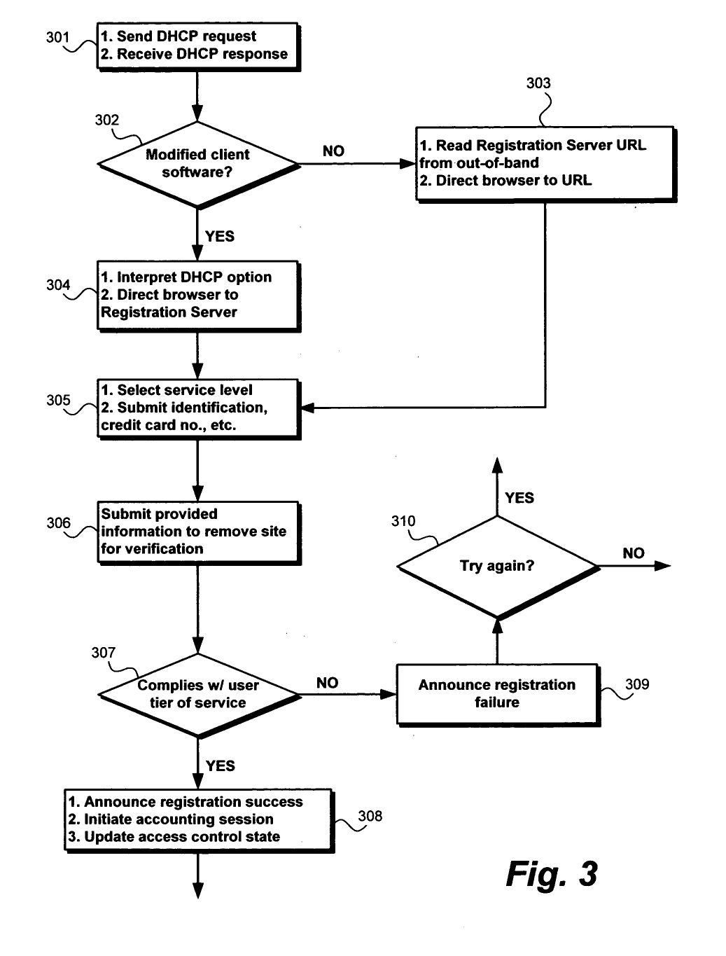

FIG. 3 shows an example of individual steps in an initial interaction of a user terminal with the system. It includes functions such as obtaining an IP address (116), contacting the registration server and selecting the desired tier of application service (115), and the resulting control notification, such as updating the state of the generic control infrastructure (117 and 203).

An embodiment of the present invention uses the standard DHCP protocol for configuring individual user terminals. After a user terminal enters the system, the physical layer of its network connection is activated, and its system software is notified. As a result, the user terminal broadcasts a DHCP request on the system network (item 1 in 301). This request is processed by the machine running the DHCP server 102, which sends back a response to the user terminal (108 and item 2 in 301). The DHCP response contains the IP address assigned to the user terminal by the system, the IP address of the default node for relaying messages (the gateway IP address) and the IP address of machine running the DNS server.

In a particular embodiment of the invention, the client configuration software is modified from its default behavior 302. For example when using the DHCP protocol, a system-specific option is added to the DHCP protocol, that can be done according to existing standards for adding options in DHCP, and the DHCP server and client software is extended to respectively generate and interpret, the new option. The system-specific DHCP option includes the address of the registration server. Upon processing the DHCP response, the extended DHCP client software, using this address, starts a browser directed to the registration server 304. Such embodiment of the invention represents one example embodiment of auto-configuration of a user terminal without explicit user intervention using an extended DHCP client and server software.

In another embodiment of the invention, no extensions are made to the DHCP protocol or to the DHCP client and server software 302. After the DHCP response is processed, and the network connection configured, a browser is started manually on the user terminal and the browser is directed to the registration server. The identity of the registration server may be available as a URL from the browser's set of bookmarks, or may be provided to the user through an out-of-band mechanism such as a visual notice 303 that may be printed or displayed prominently in the public place. While DHCP is the most common mechanism for initial configuration of user terminals, alternative configuration protocols can be used just as effectively.

For example, the next generation of the Internet Protocol, IPv6, allows a node to auto-configure itself without any help from the DHCP server. Also, using techniques like destination redirection, Web requests from a client devices to a destination Web may be redirected to any desired location, for example, the registration server, independently to where on the Internet the browser user would like to go. This invention is equally applicable to such alternative means of initial user terminal configuration.

As part of the user interaction with the registration server, the user will then select the desired tier of application service and provide the payment-related information 305. This information is then sent by the registration server/authority to an appropriate, logically distinct, node for verification 306. If the user-supplied information is validated to be correct 307, the registration is considered successful. In this case, the accounting process for this user session is initiated, and the appropriate information is relayed to the generic control infrastructure element(s) via the control notification messages 308. If the information is invalid 307, the user is generally offered another chance to register with the system 310.

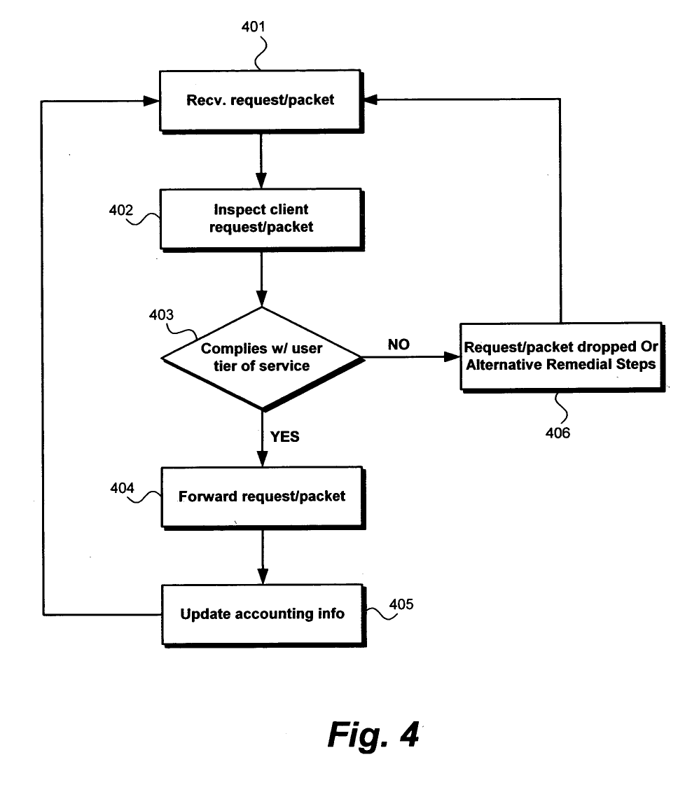

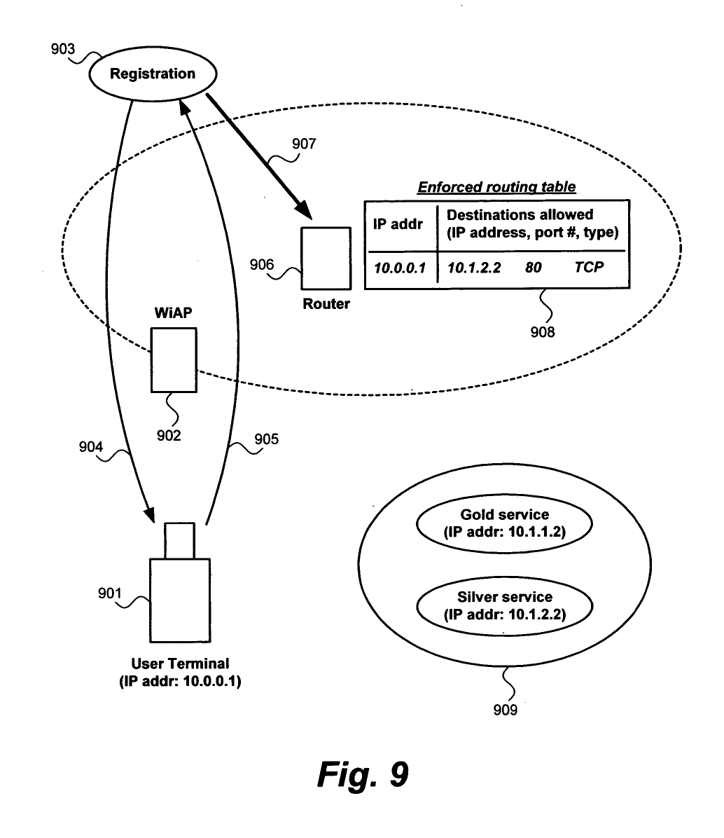

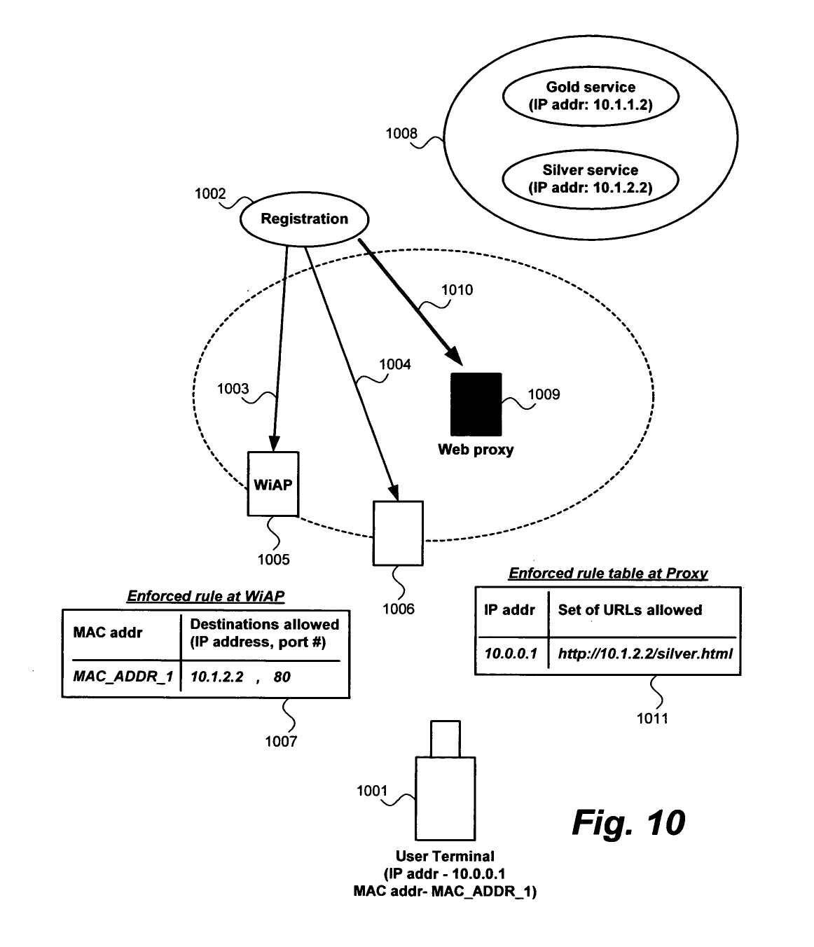

Once the user's choice of a specific application service tier has been successfully acknowledged by the system, we can expect the user to initiate transmissions to the application services in that tier. FIG. 4 shows steps followed in an example process by an element of the generic access controllable infrastructure, 204 in FIG. 2, during such communication. After receiving a packet (a request packet or any other transmission from a device) 401, the packet is inspected to determine its origin, i.e., user terminal, and the application service tier it belongs to 402. A mechanism by that the packet is related to a particular user terminal and/or tier of application service depends upon the precise element in the controllable access infrastructure where this enforcement is carried out. This is described for the case of a router in FIG. 9 and a case of the wireless access point or the Web proxy in FIG. 10. If the application service complies with the tier of service associated with the packet origin 403, the packet is forwarded to the next hop 404 and, if necessary, the accounting information associated with the origin user terminal is updated 405, in the case that the charging policy for the particular application service so requires. If the application service does not comply 403, the packet is either dropped or appropriate remedial steps are taken 406. In either case, the infrastructure element starts processing the next packet. If the compliance test is failed 403, then the system may wish to take alternative remedial measures.

In some embodiments, the enforcement node redirects the packet, and/or generates a failure notification to the registration server. If the packet that failed the compliance test corresponds to a Web-based request, the registration server could then respond, using the HTTP protocol, to the user terminal with a notification that the user had attempted an access in violation of the user's current tier of application service. This Web-based notification could provide the user with an option of renegotiating the tier of application service, in order that subsequent access attempts by the user would not be denied.

Depending on information provided by the user at registration time and the capabilities of the system, another remedial action would be to send an “out-of-band” notification to the user. The latter case may be desirable when the user does not currently use a Web-browser application, or does not contain any specialized application to that a message can be sent by the system. Out-of-band notifications may include the transmission of a message to a pager, an interactive personal e-mail device, e.g., a wireless personal device, a phone call to a cellular phone, an SMS (short message service) message, and so on.

We next describe the process by that the user can renegotiate or change their tier of application service during an ongoing association with a public access network. As explained above, this might be used when a user discovers that a specific desired application service is currently outside the scope of that user's current tier selection. Alternatively, the user may also find, at some point, the need to temporarily switch to a different tier of application service. For example, the user may suddenly find a need to access a premium application service that was not covered in the originally selected application service tier. Note that an application service profile is sometimes created and stored for a user pointing to a preferred selection of an application service tier under certain conditions or when particular properties are satisfied, e.g., based on a location property. A user's service profile could facilitate the selection of the application service tier.

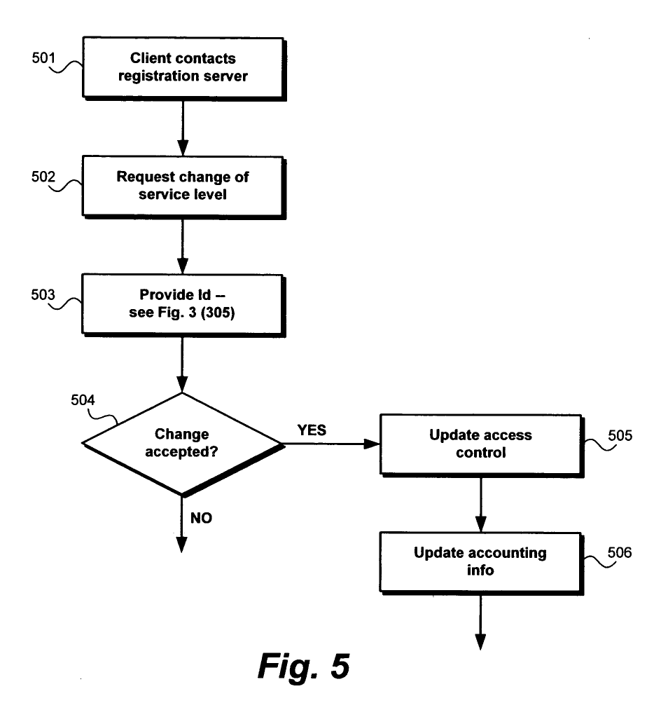

Although the embodiments of the invention described herein refer to a user selection of a service selection, the use of service profiles for facilitating a user tier selection is not outside the spirit of this invention. FIG. 5 shows steps included in changing the tier of application service associated with a user terminal. The user terminal contacts the registration server by directing a browser to the registration server 501, requests a change of the current tier of application service 502, and provides all the necessary information 503 (similar to 305). If the information is valid 504, the change is accepted and the state of the access control 505 and accounting 506 element(s) in the generic infrastructure is updated. Since the user terminal already has an existing association (and thus a unique identifier) with the access network, the process of providing the necessary information 503 may not be as detailed as the original process, 305 in FIG. 3. For example, the user may not need to re-furnish personal information (e.g., credit card numbers); rather the software on the user terminal may be capable of directly furnishing the user-specific identifier (e.g., by using a Web cookie) to the registration server, thereby helping the server to relate this request for change in application service tier to an existing user-network association.

While the procedure for upgrading the service described in FIG. 5 represents one embodiment of this invention, others are also possible without departing the spirit of this invention. For example, those skilled in the art may achieve similar results by having the user pointing to the desired application service and the service provider responding with the appropriate registration page for the tier of application service that includes the requested application service. This latter approach does not request a user to explicitly contact the registration server for the upgrade. However, it achieves the same end result as the embodiment shown in FIG. 5.

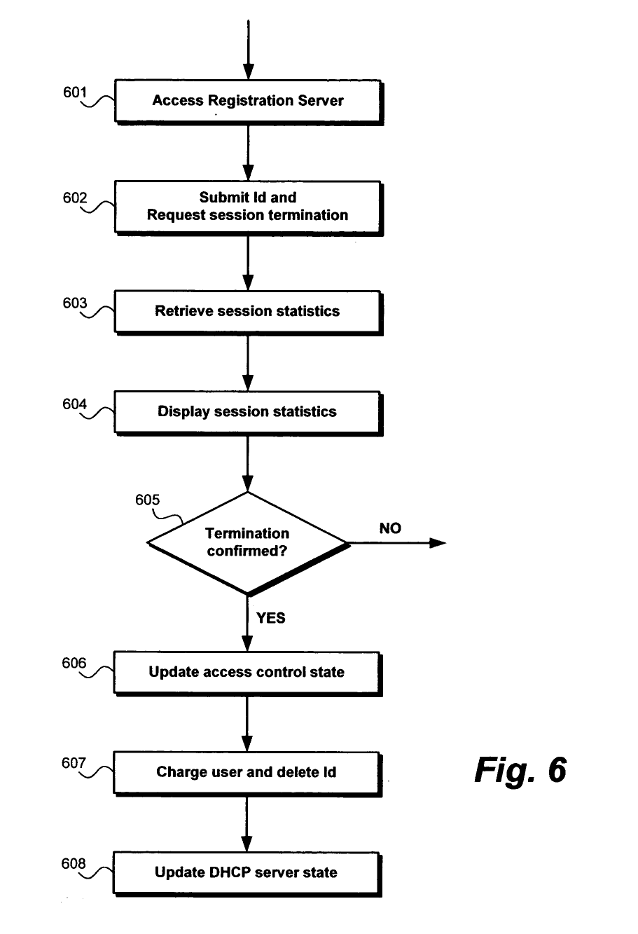

Since the support for dynamically defined application services is an element of this invention, one should specify a mechanism by that such service associations may be terminated. For example, such a de-registration mechanism is useful for accurate billing in scenarios where the user is charged on the basis of the duration of the user-network association. Such a mechanism may also be used by a user to check current usage and billing information before making a decision regarding continuation or termination of the association. FIG. 6 shows steps in a (potentially) final interaction of a user terminal with a public access network, when-the user terminal effectively closes all sessions and terminates its access to the various network services. In the embodiment shown, the user terminal directs a browser to the registration server 601 and uses the standard HTTP protocol to request the termination of its session 602. As part of this request, the user terminal may include a user-specific unique identifier 602 established during the registration process (see 201 in FIG. 2).

The registration server then retrieves the appropriate usage statistics from the relevant enforcement devices 603 and provides the appropriate usage information 604 to the user terminal. Based on this usage information, users will then decide 605 to either confirm the termination of their association or to continue utilizing the publicly available service infrastructure. If a user decides to continue, then the termination process is suspended, and the user resumes his or her normal network access. This mechanism provides users a means to simply verify their activity history and associated charges. If a user, however, decides to terminate their current association 605, the registration server will take the steps needed to remove the information related the user's presence in the public access network. The registration server will first issue the appropriate control notification messages 606 to the enforcement device(s) to disable any further access by the user terminal. Successful execution of such control messages effectively removes unnecessary access control information in the enforcement devices. It also acts as a mechanism to guard against any subsequent unauthorized access attempts. After sending this notification, the registration server will also remove the active user-specific information (such as the unique identifier related to the user's current sessions) from its internal tables, and complete the process of appropriately charging the user 607. In addition to notifying the access control devices, the registration server will also inform the DHCP server 608, so that the DHCP server can update its own tables and release resources appropriately.

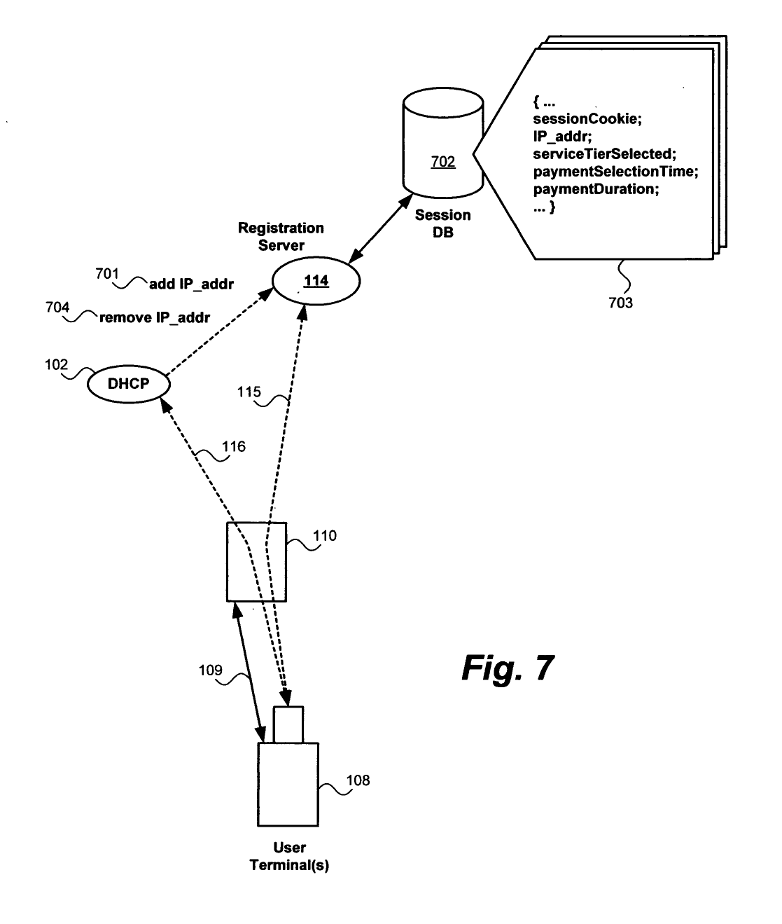

FIG. 7 shows another example embodiment for managing and terminating a session without the user having to explicitly act for the termination. In this embodiment the Web technology, called cookies, is used to follow the presence of a user terminal 108 in the system. FIG. 7 repeats pertinent portions of FIG. 1 with the addition of the session database 702 that keeps records 703 of terminals in the system. In particular, following the assignment 116 of an IP address to the user terminal by the DHCP server 102, the server informs 701 the registration server 114 that a new IP address has been assigned to a user terminal. In one embodiment the registration enters this IP address in a “standby” pool of IP addresses. The IP address will be removed from the standby pool when the user accesses the registration server to register for a new service, continue or update an existing service. In another embodiment, the registration server associates this IP address with a record 703 in a user session database 702. In any case, the registration server is notified of a new IP address assignment.

The new IP address assignment may indeed be given to a brand new user terminal, or a terminal that may have an ongoing session. The latter case may occur when for various reasons, such as temporary link 109 failure, user device reboot, change of the wireless access point due to mobility, adjustment of the access technology from, say, wireless LAN to wired Ethernet, to Bluetooth wireless technology, and so on. The user device may obtain a brand new IP address that is different than the one previously used. However, the user may have selected a payment policy that is still valid. For example, the user may have requested a 30-minute block of time, and the communications interruption happened between minutes 7 and 10 from this block of time. In this case, the brand new IP address should not be associated with an entirely new session but used instead to update session information related to the existing session.

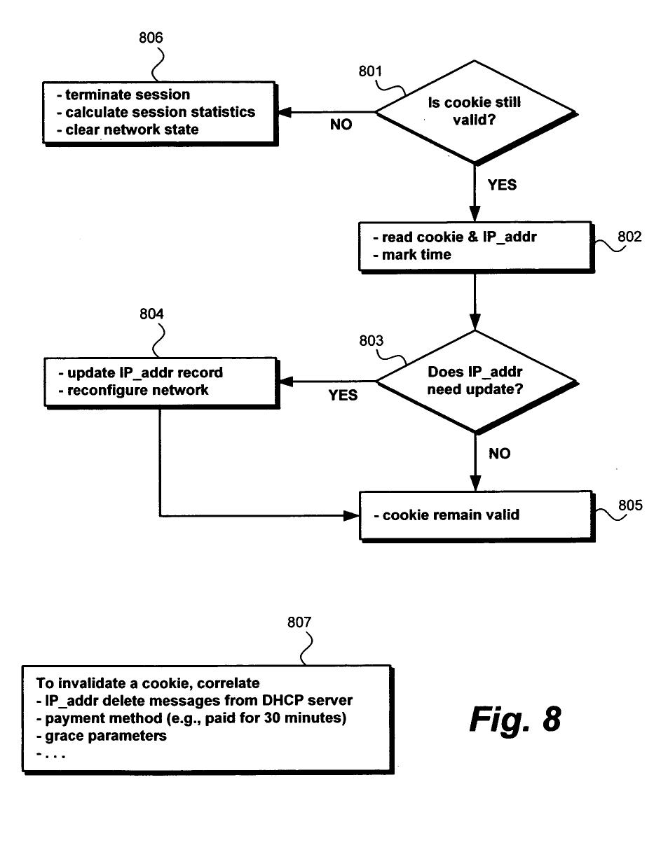

In the embodiments depicted in FIG. 7, and FIG. 8, this is accomplished through the use of Web cookies. A Web cookie is a small piece of information that a Web server sends to a Web browser that interacts with the server. The Web browser stores the cookie locally in the user terminal running the browser. This cookie is uploaded by the browser each time the particular Web browser revisits the particular Web server. This could be used to track user visits to a particular Web site. In our case, when a user terminal revisits the registration server following the reassignment of a new IP address to it, the cookie can be provided again to the registration server and the registration can use this cookie to retrieve the session record (if one exists) for this user terminal, and update it accordingly.

In yet another embodiment, the transmission of the new IP address from the DHCP server to the registration server is omitted. It allows session data for newly initiated sessions or ongoing sessions to be handled exclusively by the registration server. This is possible because Web servers, like the registration server, apart from the cookie, can retrieve a large amount of information pertaining the user terminal, including its IP address. However, the IP address transmission in 701, or a similar address in the opposite direction, is something used to verify that the IP address used by the client device is a legitimate IP address assigned by the DHCP server.

FIG. 8 shows an embodiment for the steps followed by the registration server to decide how to proceed if it receives a cookie. A cookie is referred to as valid, if it is associated with an active/ongoing session. To invalidate a cookie a number of events 807 may contribute. For example, the DHCP server may invalidate an IP address. This happens when the “lease” time associated with an IP address assigned by the DHCP server expires before the user terminal requests renewal of the lease. In the embodiment of FIG. 7, the DHCP server communicates this information by transmitting a “remove IP address” message 704. The granularity of the DHCP leases dictates how accurately a pay-while-I-am-on billing policy could be; for example, if the leases are given in two-minute increments, then a user that chooses to pay based on the duration of her session will be billed for using the system for 2, or 4, or 6, and so on, minutes. A session may also be invalidated if a user has selected to pay for a block of 30 minutes and the 30 minutes have passed. In the session record 703 in FIG. 7, the latter can be calculated from the session record entries describing the selection time of a payment policy (paymentSelectionTime) and/or the time covered by the selected payment policy (paymentDuration), or other pertinent data stored in the session record. The time of selecting a payment may be tight with the time that a tier of service is selected, but this is not generally a requirement. The various time intervals may be further associated with grace periods to account for the possibility that the user has temporarily disconnected. These grace periods are advantageously coordinated with the DHCP server, so that the DHCP server does not assign an already removed IP address to a new user terminal, but the registration server has not updated its session records yet.

Momentary connection interruptions can occur due to user mobility and other reasons such as: temporary link failure; user device reboot; change of the wireless access point due to mobility; adjustment of the access technology from, say, wireless LAN to wired Ethernet, to Bluetooth wireless technology; and so on. Through the use of cookies that are sometimes used as session identifiers that can persist past the connectivity interruption, users can continue accessing the selected tier of services without the need to reregister with the registration server. Using the cookie that a user terminal sends every time it access the registration server, the registration server can restore any session information that it needs ignoring the connectivity interruption caused by any number of reasons. This capability is frequently referred to as service roaming.

FIG. 9 shows more details on how access control can be enforced by using a router in the access network 101 in FIG. 1, or the equivalent controllable infrastructure 204 in FIG. 2. In FIG. 9, it is assumed that a user terminal 901 is assigned the IP address, 10.0.0.1, using the DHCP protocol; in other embodiments this and the IP addresses that follow could be different. Additionally, we assume that the service provider has defined two application service tiers, Gold and Silver, that allow the user to access the devices with IP addresses 10.1.1.2 and 10.1.2.2 respectively. (The generalization to multiple application service tiers, each with multiple lists of IP addresses and/or port numbers is straightforward to those familiar with the art.) The client then contacts the registration authority 903 via a wireless access point 902, to specify its desired tier of application services. The registration authority 903 provides 904 a Web page listing of all the available tiers of application service, and their associated charges. The user then chooses between the two tiers of application service 909 (Gold or Silver) and sends this choice back 905 to the registration server (along with other personal credentials). The grouping of services into the various application service tiers could be incremental, in that, say, the selecting the Gold service tier may enable access to all the services in the Silver service tier as well.

Let us assume that the user terminal has chosen the Silver tier of service. One of the nodes where the access control mechanism can be enforced is the router 906. As shown in FIG. 9, this router-based access control scheme can be achieved by communicating a set of filtering rules 907, based on the IP address of the user terminal and its requested application service tier, to the router. Upon reception of these filtering rules, the router stores them in its local routing table 908. In FIG. 9, the routing table shows that IP address 10.0.0.1 (the IP address of the user terminal in question) can access application services offered on TCP port 80 on destination address 10.1.2.2. This corresponds to the Web server for the Silver service; accordingly, the user terminal associated with IP address 10.0.0.1 can access only the Silver service.

The enforcement mechanism can also be performed at alternative nodes in the access network infrastructure, such as the wireless access points or at a Web proxy. These alternatives are shown in FIG. 10, where we assume, as before, that the user terminal has the IP address 10.0.0.1. Moreover, let us assume that the hardware (MAC) address of the wireless device associated with the user terminal is “MAC_ADDR_{—}1”. First, as depicted on the left side of the figure, the registration authority 1002 may pass a set of filtering rules 1003, 1004 to one or more wireless access points (WiAPs) 1005, 1006. Since the wireless access point distinguishes terminals by the MAC address, the filtering table 1007 in a wireless access point (1005 in FIG. 10) will typically contain the MAC address of the user terminal (in our example, this is “MAC_ADDR_{—}1”) and the destination IP addresses and/or port numbers of the set of permissible destination nodes. Again, the figure shows an example where the user terminal has selected the Silver tier of application service 1008 (destination address 10.1.2.2).

The right side of FIG. 10 depicts the case when access control is enforced via placement of a filter at a Web proxy 1009. In this case, the registration authority 1002 passes the appropriate set of filtering rules 1010 to the Web proxy. The Web proxy then updates the corresponding information in its filtering table 1011. It should be understood that this is really an application-layer filtering mechanism, since the Web proxy intercepts only that traffic from the user terminal that is Web-based. In this case, the user terminal may be uniquely identified by either a network-layer identifier, such as the IP address (10.0.0.1 in our example) or by an application-layer identifier, such as a collection of Web cookies.

FIG. 10 shows a case when the filtering table 1011 identifies the user terminal via its IP address (10.0.0.1), and the set of permitted destinations through a set of URLs (uniform resource locators). In this particular example, we assume that the user has chosen the Silver service that is associated with the URL http://10.1.2.2/silver.html. Uniform Resource Locators (URLs) are the standard way to name, discover and retrieve objects on the Web.

The embodiments of the invention discussed herein relate to using access points, routers, and Web proxies to control access to the selected application services. Those skilled in the art may use alternative network traffic control elements without departing from the spirit of this invention.

The embodiments of the invention presented thus far are based on an assumption that the public access infrastructure uses a wireless LAN to allow users to connect to the network via a wireless interface. However, the principles and methods described in this invention may be applicable to other wireline and wireless access technologies. Those skilled in the art may easily develop additional embodiments of this invention for alternative access technologies, for example, using wireline IEEE 802.3 Ethernet technology instead of the IEEE 802.11 wireless LAN technology, without departing from the spirit of this invention.

The present invention can be realized in hardware, software, or a combination of hardware and software. A visualization tool according to the present invention can be realized in a centralized fashion in one computer system, or in a distributed fashion where different elements are spread across several interconnected computer systems. Any kind of computer system—or other apparatus adapted for carrying out the methods and/or functions described herein—is suitable. A typical combination of hardware and software could be a general purpose computer system with a computer program that, when being loaded and executed, controls the computer system such that it carries out the methods described herein. The present invention can also be embedded in a computer program product, that comprises all the features enabling the implementation of the methods described herein, and that—when loaded in a computer system—is able to carry out these methods.

Computer program means or computer program in the present context include any expression, in any language, code or notation, of a set of instructions intended to cause a system having an information processing capability to perform a particular function either directly or after conversion to another language, code or notation, and/or reproduction in a different material form.

Thus the invention includes an article of manufacture that comprises a computer usable medium having computer readable program code means embodied therein for causing a function described above. The computer readable program code means in the article of manufacture comprises computer readable program code means for causing a computer to affect the steps of a method of this invention. Similarly, the present invention may be implemented as a computer program product comprising a computer usable medium having computer readable program code means embodied therein for causing a function described above. The computer readable program code means in the computer program product comprising computer readable program code means for causing a computer to effect one or more functions of this invention. Furthermore, the present invention may be implemented as a program storage device readable by machine, tangibly embodying a program of instructions executable by the machine to perform method steps for causing one or more functions of this invention.

It is noted that the foregoing has outlined some of the more pertinent objects and embodiments of the present invention. This invention may be used for many applications. Thus, although the description is made for particular arrangements, timing indications and methods, the intent and concept of the invention is suitable and applicable to other arrangements and applications. It will be clear to those skilled in the art that modifications to the disclosed embodiments can be effected without departing from the spirit and scope of the invention. The described embodiments ought to be construed to be merely illustrative of some of the more prominent features and applications of the invention. Other beneficial results can be realized by applying the disclosed invention in a different manner or modifying the invention in ways known to those familiar with the art.

1. A method for employing at least one standard protocol for a device coupled to a network to access a particular group of application services, the method comprising:
creating at least one plurality of groups of application services accessible to said device dynamically from a list of possible application services;
providing the at least one plurality of groups of application services to said device;
allowing said device to select said at least one plurality of groups of application services; and
automatically configuring said network dynamically based on said selected groups of application services to permit access by said device to said selected groups of application services via said network.

2. A method as recited in claim 1, further comprising:
enabling said device to make a subsequent selection of another group of application services from said plurality of groups; and
automatically reconfiguring said network dynamically based on said subsequent selection permitting access to said another group of application services by said device via said network.

3. A method as recited in claim 1, wherein the network utilizes a standard TCP/IP communication protocol.

4. A method as recited in claim 1, wherein said set of standard communication protocols includes a standard IEEE 802 communication protocol.

5. A method as recited in claim 1, wherein the step of providing includes retrieving a list of said at least one plurality of groups of application services from local data.

6. A method as recited in claim 1, wherein the step of providing includes retrieving a list of said at least one plurality of groups of application services over said network from a group of apparatuses located remotely from said device.

7. A method as recited in claim 6, wherein the step of providing is initiated by said group of apparatuses and includes the transmission of unsolicited messages by said group of apparatuses to said device.

8. A method as recited in claim 7, wherein the content of said unsolicited messages depends on at least one property associated with said device.

9. A method as recited in claim 6, wherein the step of retrieving includes employing a Web browser application coupled to said device and a Web server coupled to said network.

10. The method of claim 1, wherein at least one of said application services are useable by said device.

11. A method as recited in claim 1, further comprising mapping said plurality of groups of application services to at least one network identifier.

12. A method as recited in claim 11, wherein said at least one network identifier includes at least one identifier taken from a group of identifiers including: IP addresses; TCP/UDP port numbers; protocol identifiers; application identifiers, and a combination of said identifiers.

13. A method as recited in claim 1, wherein the step of automatically configuring includes setting up traffic filtering rules in said network, wherein said traffic filtering rules associate said device with said particular group of application services.

14. A method as recited in claim 13, wherein said traffic filtering rules are set in at least one network traffic control element from a group of network traffic elements coupled to said network, said group of network traffic control elements including: data access points; bridges; switches; hubs; routers; gateways; proxy servers; Web servers; and any combination of these.

15. A method as recited in claim 14, wherein said traffic filtering rules are based on at least one identifier from a group of identifiers, said group of identifiers including: user of a device; said device medium access control (MAC) addresses; said plurality of groups of application services medium access control (MAC) addresses; said device IP addresses; said plurality of groups of application services IP addresses; said device TCP/UDP port numbers; said plurality of groups of application services TCP/UDP port numbers; universal resource locators (URLs); and any combination of these identifiers.

16. A method as recited in claim 2, further comprising charging a fee for accessing at least one of said plurality of groups of application services by said device, wherein the step of charging a fee includes providing alternative charging policies associated with each group of application services selectable from the device.

17. A method as recited in claim 16, wherein said alternative charging policies are based on at least one policy from a group of alternative charging policies including:
time-based charging policy, where the fee depends on a duration of time said network remains configured to enable access by said device to said particular group of application services;
time-based charging policy with a preselected amount of time;
time-based charging policy with an amount of time dynamically reset until said device ceases accessing said particular group of application services;
per minute, hour, day, or monthly service subscription rates;
usage-based charging policy, where the amount of charging depends on the amount of traffic passed through the network between said device and application services in said particular groups of application services, as long as said network remains configured to enable access by said device to said particular group of application services;
usage-based charging policy with a preselected amount of traffic; and
any combination of the above charging policies.

18. A method as recited in claim 16, wherein the step of charging includes associating said fee with the user of said device, and including in said step of associating the step of providing at least one user identification from a group of user identifications including: credit card information; frequent-flyer information; customer loyalty information; application service subscription information; hotel-room information; user ID/password information; and personal information embedded in a personal smart card, and a combination of said identifications.

19. A method as claimed in claim 1, further comprising prohibiting access to another group of application services.

20. A method as claimed in claim 19, further comprising:
defining said another group of application services as prohibited services;
allowing the at least one of said prohibited services from said plurality of application services to be selected from the device; and
automatically reconfiguring said network dynamically based on said particular group of application services to permit access to said at least one of said prohibited services by said device via said network.

21. A method as claimed in claim 20, further comprising charging a fee for access of said at least one of said prohibited services, wherein said fee is adjusted based on user selected charging policy pertaining to said at least one of said prohibited services.

22. A method as recited in claim 19, further comprising sending notification to at least one of said device and another device, to indicate that access to said another group of application services is prohibited.

23. A method as recited in claim 1, wherein the step of providing is based on at least one property associated with said device.

24. A method comprising:
enabling a user device coupled to a network, said user device employing a set of standard protocols, said network including: at least one network configuration service; at least one services management application service; at least one network traffic control element, and at least two groups of application services accessible to said user device, said at least one network configuration service configuring said user device, said at least one services management application service providing said user device with a listing of said at least two groups of application services, wherein said at least one services management application creating at least one of said at least two groups of application services dynamically from a list of possible application services;
allowing a user of said user device to select at least one group from said at least two groups of application services; and
automatically configuring said at least one network traffic control element dynamically to enable access only to said at least one group.

25. A method comprising:
providing a listing of a plurality of groups of application services, wherein at least one of said plurality of groups of application services is created dynamically from a list of possible application services, to a user device in response to said device connecting to a network;
sending to said device a set of identifiers representing a selection of a particular group of application services from said plurality of groups of application services; and
employing said identifiers to instruct at least one network traffic control element to automatically and dynamically configure said network in order to enable communication between said device and said particular group of application services over said network.

26. A method comprising:
setting access permission for a device;
allowing said device to select access to selected application services from a plurality of groups of available application services, said device employing a set of standard protocols and being coupled to a network;
associating said access permission for said device with at least one identifier in order for said device to access said selected application services from at least one of said plurality of groups of application services; and
using said at least one identifier to enable said device to roam and have access to said selected application services employing said established access permission.

27. A method as recited in claim 26, further comprising maintaining said established access permission even when network coupling conditions change.

28. An apparatus comprising:
a server to allow a user to employ a set of standard communication protocols on a device coupled to a network to access a particular group of application services, said server including:
a listing module for providing a listing of a plurality of groups of application services accessible to said device, at least one of said application services in each of said groups being useable by said device, wherein at least one of said plurality of groups is created dynamically from a list of possible services;
an enabling module to enable said user to select said particular group of application services from said plurality of groups; and
a configuration module to automatically configure said network dynamically based on said particular group of application services to permit said access by said device to said particular group of application services via said network.

29. An apparatus as recited in claim 28, wherein said enabling module enables said user to make a subsequent selection of another group of application services from said plurality of groups, and wherein said configuration module automatically reconfigures said network dynamically based on said subsequent selection to permit said access to said another group of application services by said device via said network; and further comprising: a billing module to charge a fee for said access, wherein the fee is based upon alternative charging policies associated with each group.

30. An article of manufacture comprising a computer usable medium having computer readable program code means embodied therein for causing automatic and dynamic configuration, the computer readable program code means in said article of manufacture comprising computer readable program code means for causing a computer to effect the steps of:
creating at least one plurality of groups of application services accessible to said article of manufacture dynamically from a list of possible application services;
providing the at least one plurality of groups of application services to said article of manufacture;
allowing said article of manufacture to select said at least one plurality of groups of application services; and
automatically configuring said network dynamically based on said selected groups of application-services to permit access by said article of manufacture to said selected groups of application services via said network.

31. An article of manufacture comprising a computer usable medium having computer readable program code means embodied therein for causing automatic and dynamic configuration, the computer readable program code means in said article of manufacture comprising computer readable program code means for causing a computer to effect the steps of:
enabling a user device coupled to a network, said user device employing a set of standard protocols, said network including: at least one network configuration service; at least one services management application service; at least one network traffic control element, and at least two groups of application services accessible to said user device, said at least one network configuration service configuring said user device, said at least one services management application service providing said user device with a listing of said at least two groups of application services, wherein said at least one services management application creating at least one of said at least two groups of application services dynamically from a list of possible application services;
allowing a user of said user device to select at least one group from said at least two groups of application services; and
automatically configuring said at least one network traffic control element dynamically to enable access only to said at least one group.

32. An article of manufacture comprising a computer usable medium having computer readable program code means embodied therein for causing automatic and dynamic configuration, the computer readable program code means in said article of manufacture comprising computer readable program code means for causing a computer to effect the steps of:
providing a listing of a plurality of groups of application services, wherein at least one of said plurality of groups of application services is created dynamically from a list of possible application services, to a user device in response to said device connecting to a network;
sending to said device a set of identifiers representing a selection of a particular group of application services from said plurality of groups of application services; and
employing said identifiers to instruct at least one network traffic control element to automatically and dynamically configure said network in order to enable communication between said device and said particular group of application services over said network.

33. An article of manufacture comprising a computer usable medium having computer readable program code means embodied therein for causing application service access, the computer readable program code means in said article of manufacture comprising computer readable program code means for causing a computer to effect the steps of:
setting access permission for a device;
allowing said device to select access to selected application services from a plurality of groups of available application services, said device employing a set of standard protocols and being coupled to a network;
associating said access permission for said device with at least one identifier in order for said device to access said selected application services from at least one of said plurality of groups of application services; and
using said at least one identifier to enable said device to roam and have access to said selected application services employing said established access permission.

34. A computer program product comprising a computer usable medium having computer readable program code means embodied therein for causing automatic and dynamic configuration, the computer readable program code means in said computer program product comprising computer readable program code means for causing a computer to effect the functions of:
a server to allow a user to employ a set of standard communication protocols on a device coupled to a network to access a particular group of application services, said server including:
a listing module for providing a listing of a plurality of groups of application services accessible to said device, at least one of said application services in each of said groups being useable by said device, wherein at least one of said plurality of groups is created dynamically from a list of possible services;
an enabling module to enable said user to select said particular group of application services from said plurality of groups; and
a configuration module to automatically configure said network dynamically based on said particular group of application services to permit said access by said device to said particular group of application services via said network.

35. A program storage device readable by machine, tangibly embodying a program of instructions executable by the machine to perform method steps for automatic and dynamic configuration, comprising the steps of claim 1.

36. A program storage device readable by machine, tangibly embodying a program of instructions executable by the machine to perform method steps for automatic and dynamic configuration, comprising the steps of claim 24.

37. A program storage device readable by machine, tangibly embodying a program of instructions executable by the machine to perform method steps for automatic and dynamic configuration, comprising the steps of claim 25.

38. A program storage device readable by machine, tangibly embodying a program of instructions executable by the machine to perform method steps for causing application service access, comprising the steps of claim 26.
